(19) United States
(12) Patent Application Publication
(10) Pub. No.: US 2020/0168984 A1
(43) Pub. Date: May 28, 2020

(54) ANTENNA DEVICE

(71) Applicant: Lynwave Technology Ltd., New Taipei (TW)

(72) Inventor: Shih-Chieh CHAO, Taoyuan (TW)

(21) Appl. No.: 16/199,442

(22) Filed: Nov. 26, 2018

(51) Int. Cl. H01Q 1/38; H01Q 15/00; H01Q 15/04

(52) U.S. Cl. CPC H01Q 1/38; H01Q 15/04; H01Q 15/0006

(57) ABSTRACT

An antenna device comprises a substrate with an installation surface, with said substrate configured to electrically connect to a ground point; a main antenna connected to the installation surface, wherein the main antenna extends away from the installation surface, has a feeding end for receiving a signal, and is configured to form a resonance current path with the substrate to generate an original radiation field; and a reflector with a shorting end and a free end, wherein the shorting end connects to the installation surface and the reflector extends away from the installation surface; and a switch with a first end, a second end, and a control end, wherein the first end electrically connects to the free end of the reflector, the second end electrically connects to the substrate, and the control end is configured to selectively control the first end and the second end in a conductive connection.

### BACKGROUND

### 1. Technical Field

This disclosure relates to an antenna device, and particularly to an antenna device with a switch.

### 2. Related Art

With the advancement of technology, communication technology has evolved from wired to wireless. Transmitting or receiving electromagnetic wave through a wireless base station to proceed a wireless communication with the mobile electronic device may avoid problems such as easy damage and difficult assembly of cables. An antenna device for transmitting or receiving wireless electromagnetic waves plays an important role in wireless communication technology, the principle is to generate a radiation field by feeding a time-vary voltage or a time-varying current.

However, mobile electronic devices are constantly changing their location. Therefore, an antenna device that can provide only a single pattern of radiation field will cause poor reception of mobile electronic devices. In order to respond to the changing positions of the mobile electronic device at any time, the wireless base station needs to have an antenna device capable of switching the radiation field pattern.

### SUMMARY

According to one or more embodiment of this disclosure, an antenna device comprising: a substrate with an installation surface, with said substrate configured to electrically connect to a ground point; a main antenna connected to the installation surface, wherein the main antenna extends away from the installation surface, has a feeding end for receiving a signal, and is configured to form a resonance current path with the substrate to generate an original radiation field; and a reflector with a shorting end and a free end, wherein the shorting end connects to the installation surface and the reflector extends away from the installation surface; and a switch with a first end, a second end, and a control end, wherein the first end electrically connects to the free end of the reflector, the second end electrically connects to the substrate, and the control end is configured to selectively control the first end and the second end in a conductive connection.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a perspective schematic view of the antenna device according to an embodiment of the present disclosure;

FIG. 1B is a circuit schematic view of the antenna device according to an embodiment of the present disclosure;

FIG. 2A is a pattern schematic view of the original radiation field generated by the antenna device according to an embodiment of the present disclosure;

FIG. 2B is a pattern schematic view of the second radiation field generated by the antenna device according to an embodiment of the present disclosure;

FIG. 3 is a perspective schematic view of the antenna device according to another embodiment of the present disclosure;

FIG. 4 is a perspective schematic view of the antenna device according to further another embodiment of the present disclosure; and

FIG. 5 is a pattern schematic view of the third radiation field generated by the antenna device according to further another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

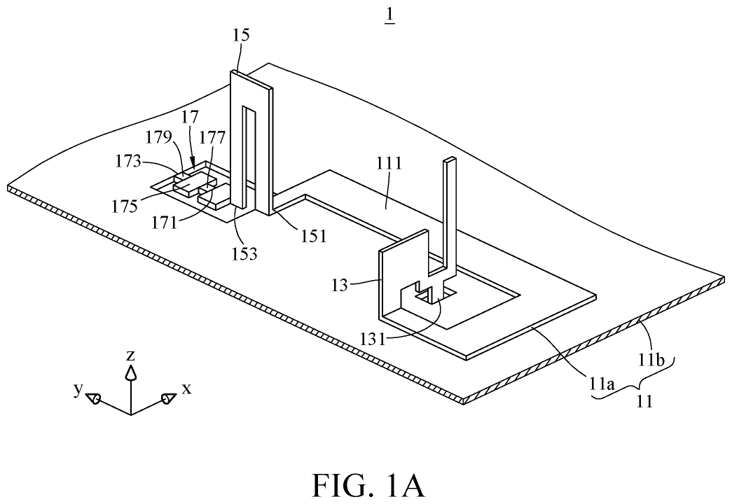

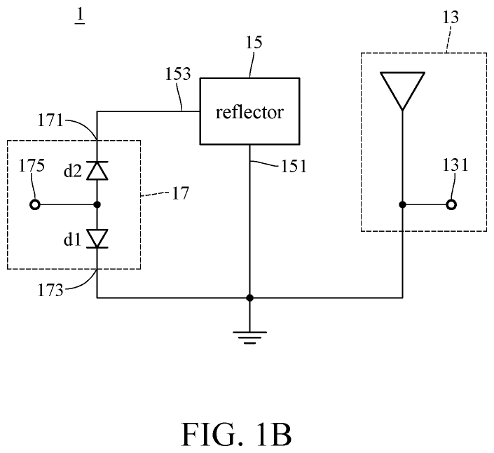

Please refer to FIG. 1 which is a . . . .

It should be noted first that the figures are merely illustrative of the basic structure of the present disclosure in order to facilitate the understanding of the figures. In actual implementation, the size and shape of the substrate, the main antenna and each reflector of the antenna device are a selective design with their layout form may be more complicated.

Please refer to FIG. 1A and FIG. 1B together to realize one of the actual aspects of the antenna device, wherein FIG. 1A is a perspective schematic view of the antenna device 1 according to an embodiment of the present disclosure and FIG. 1B is a circuit schematic view of the antenna device 1 according to an embodiment of the present disclosure.

As shown in FIG. 1A, the antenna device 1 comprises a substrate 11, a main antenna 13, a reflector 15, and a switch 17. The substrate 11 of the antenna device 1 has an installation surface and is configured to electrically connect to a ground point. In the embodiment shown in FIG. 1A, the substrate 11 comprises a first substrate 11a and a second substrate 11b, both of them are electrically connected to each other, wherein the first substrate 11a has an irregular shape, especially it should be noted that said irregular shape may be different depending on the design of the system, the electronic device, and the like to which the antenna device 1 of the present disclosure is applied, and is not limited thereto.

The main antenna 13 of the antenna device 1 connects the installation surface 111 of the substrate 11, extends away from the installation surface 111, and has a feeding end 131 for receiving and sending signals (such as voltage or current signals). For example, the feeding end 131 may electrically connect to the external transceiver to receive or send signals, the present disclosure does not limit the resource of signals. The main antenna 13 is configured to form a resonance current path with the substrate 11 to generate an original radiation field. Further, the main antenna 13 may receive signals through the feeding end 131, said signals may form the resonance current path on the main antenna 13 and the substrate 11, with the radiation field further generated.

The reflector 15 has a shorting end 151 and a free end 153, wherein the shorting end 151 connects the installation surface 111 and the free end 153 connects the substrate 11 through the switch 17. In detail, the shorting end 151 of the reflector 15 connects the first substrate 11a, the free end 153 connects the second substrate 11b through the switch 17. The reflector 15 is spaced apart from the main antenna 13 on the installation surface 111 of the substrate 11 and extends away from the installation surface 111. In the embodiment shown in FIG. 1A, the reflector 15 is a structure in an upside down U-shape. In detail, one end of the structure connects the installation surface 111 of the substrate 11 to serve as the shorting end 151 of the reflector 15 while another end of the structure extends in the direction to the installation surface 111 of the substrate 11 to serve as the free end 153 of the reflector 15. In other embodiments, reflector 15 may be also designed in other shape and is not limited to the structure shown in FIG. 1A.

In order to make the relative orientation in the figures simple and easy to understand, the lower right corner of FIG. 1A shows a three-dimensional coordinate axis for indicating the relative orientation of the components of the antenna device 1. In FIG. 1A, the substrate 11 of the antenna device 1 is located on the xy plane (the plane formed by the x-axis and the y-axis), and the main antenna 13 and the reflector 15 extend vertically away from the substrate 11 in the z-axis direction. However, the reflector 15 and the main antenna 13 may extend in the same non-vertical direction away from the substrate 11 or may extend in different directions and the present disclosure is not limited.

As described above, the free end 153 of the reflector 15 may connect the substrate 11 through the switch 17. The circuit schematic view of the antenna device 1 is firstly used to explain the arrangement and the operation of the switch 17, as shown in FIG. 1B, the switch 17 has a first end 171, a second end 173, and a control end 175. The first end 171 of the switch 17 electrically connects to the free end 153 of the reflector 15, the second end 173 electrically connects to the substrate 111 and the control end 175 is configured to selectively control the first end 171 and the second end 173 in a conductive connection, that is, to control the disconnection or short circuit between the first end 171 and the second end 173. For example, the control end 175 may electrically connect to the controller or another control circuit to receive control instructions from the controller or the control circuit, then control the first end 171 and the second end 173 in a conductive connection according to control instructions. The present disclosure does not limit the source of control instructions.

In the embodiment shown in FIG. 1B, the switch 17 may comprise two diodes d1 and d2, wherein two cathode ends of the diode d1 and d2 serve as the first end 171 and the second end 173 of the switch 17 respectively, and two anode ends of the diode d1 and d2 are electrically connected to each other to serve as the control end 175 of the switch 17 controlled by the controller or the control instruction of the control circuit. In this embodiment, when the voltage set in the control instruction is higher than the voltage of the barrier potential of the diode d1, d2, the first end 171 and the second end 173 of the switch 17 stay in a conducting state. On the contrary, when the voltage set in the control instruction is lower than the voltage of the barrier potential, the first end 171 and the second end 173 of the switch 17 are open.

In another embodiment, the switch 17 may comprise a MOSFET (Metal-Oxide-Semiconductor Field-Effect Transistor). Taking NMOS (N-channel MOSFET) for example, the source and drain of the NMOS may be used as the first end 171 and the second end 173 of the switch 17 and the gate is used as the control end 175 of the switch 17. When the voltage set in the control instruction is higher than the threshold voltage of the NMOS, the first end 171 and the second end 173 of the switch 17 are electrically connected (i.e., the switch 17 is closed). On the contrary, when the voltage set in the control instruction is lower than the threshold voltage, the first end 171 and the second end 173 of the switch 17 are open. According to the above description, a person of ordinary skill in the art may also use a P-channel MOSFET to implement the switch 17 of the antenna device 1, thus not described here. In addition to the diode and the MOSFET described above, the switch 17 may also be implemented by other switch component or circuit and the present disclosure does not limit.

Using a perspective schematic view of the according to an embodiment of the present disclosure to explain the structure of the switch 17 as shown in FIG. 1A, the first end 171 of the switch 17 may connect the free end 153 of the reflector 15 through the bonding pad and the second end 173 bonds the second substrate 11b. In this embodiment, the switch 17 comprises a bonding pad as the control end 175 for receiving a control signal and comprises a first element 177 and the second element 179 respectively connect two ends of the bonding pad as the control end 175. In detail, the first and the second element 177 and 179 may be diode d1 and d2 of the embodiment as shown in FIG. 1B.

In the embodiment as shown in FIG. 1A, the first substrate 11a, the main antenna 13, and the reflector 15 of the antenna device 1 may be integrally formed by bending a conducting material, then soldering the first substrate 11a on the second substrate 11b and soldering the free end 153 of the reflector 15 on the second substrate 11b through the switch 17. In another embodiment, the above components may also be made separately and then being fabricated to assembly the antenna device 1, that the present disclosure is not limited. Said conducting material is metal material such as copper, aluminum and is not limited herein.

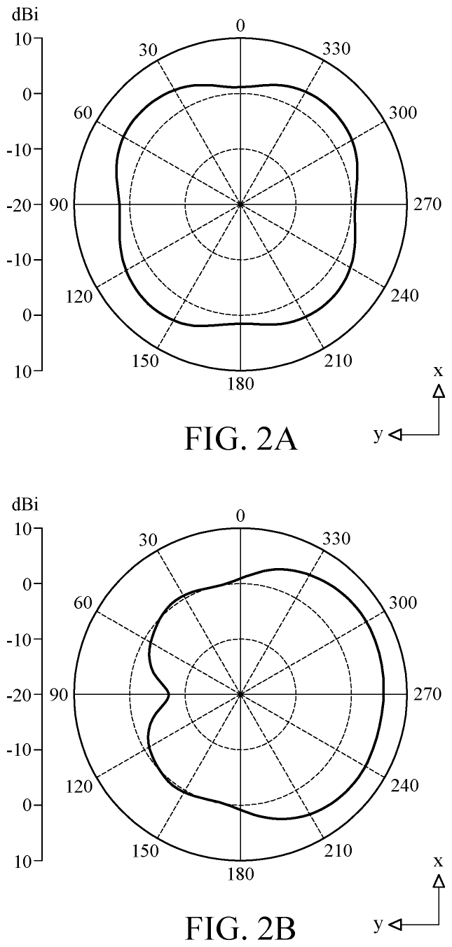

Next, please refer to FIG. 1A, FIG. 2A, and FIG. 2B together to illustrate the radiation fields of the antenna device 1 having different patterns according to whether the switch 17 is closed or open, wherein FIG. 2A is a pattern schematic view of the original radiation field generated by the antenna device 1 according to an embodiment of the present disclosure and FIG. 2B is a pattern schematic view of the second radiation field generated by the antenna device 1 according to an embodiment of the present disclosure.

It should be particularly noted that the radiation pattern actually generated by the antenna device 1 belongs to a three-dimensional irregular spherical shape. To simplify the description, FIG. 2A and FIG. 2B are schematic views of a two-dimensional pattern based on pattern data measured in a direction vertical to the substrate 11. FIG. 2A and FIG. 2B respectively comprise multiple concentric circles, wherein the center of concentric circles indicates the center point of the aforementioned antenna device 1, that is, the position where the main antenna 13 is located. The circumference of each concentric circle of different radii represents the radiation intensity with different decibel values (dBi), where the outermost circle is 10 dBi and the center of the circle is −20 dBi. A plurality of azimuth angles, which are from 0 to 330 degrees with 30 degrees apart, are marked in a counterclockwise direction outside the outermost concentric circle, wherein an axis formed by zero-degree angle and 180-degree angle corresponds to the y-axis shown in FIG. 1A and another axis formed by 90-degree angle and 270-degree angle corresponds to the x-axis shown in FIG. 1A. The illustration manners of pattern figures of the radiation field corresponding to the implementations of other antenna devices are similar to those described above, and will not be described again afterward.

In this embodiment, the reflector 15 is oriented at an angle of 90 degrees. When the switch 17 of the antenna device 1 is open, that is, the first end 171 and the second end 173 of the switch 17 are not electrically connected (i.e., the switch 17 is open), the antenna device 1 generates the original radiation field generated by the main antenna 13. The original radiation field has a pattern as shown in FIG. 2A. In detail, when the switch 17 is open, the equivalent length of the reflector 15 is about one-half of the wavelength of corresponding to the antenna resonant frequency (i.e., the resonant frequency of the main antenna 13 and the substrate 11), the reflector 15 has no reflection effect at this time, so the radiation field generated by the antenna device 1 is the original radiation field generated by the main antenna 13.

In contrast, when the switch 17 is closed, the antenna device 1 generates the second radiation field according to the original radiation field, wherein the second radiation field has a pattern as shown in FIG. 2B. In detail, when the switch 17 is closed, the equivalent length of the reflector 15 is one quarter of the wavelength corresponding to the antenna resonant frequency. At this time, the reflector 15 may reflect the original radiation field generated by the main antenna 13 to generate the second radiation field whose pattern is shown in FIG. 2B. In detail, in this embodiment, the reflector 15 is oriented at an angle of 90 degrees, and the reflector 15 may reflect the original radiation field of main antenna 13 when the switch 17 is closed and connecting to the ground, so that the antenna device 1 emits electromagnetic wave in a direction of 270-degree angle.

In the above embodiment, since the switch 17 is disposed between the reflector and the ground point, when the antenna device 1 is switching by the switch 17 to change the pattern of the generated radiation field, the power supply of the signal source can be maintained without interruption, further the delay caused by signal source interruption can be prevented and the radiation pattern switching without time difference can be achieved.

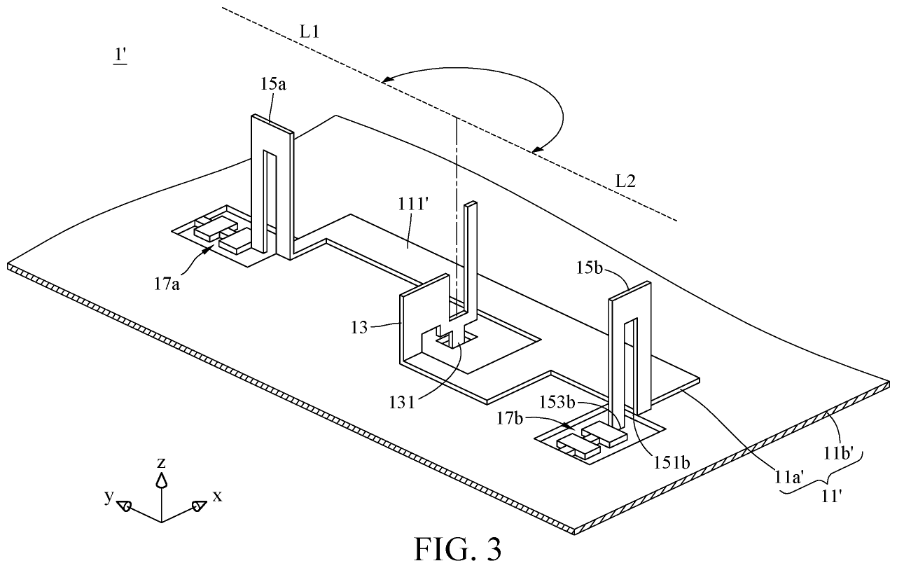

The antenna device 1 in the above embodiment comprises a reflector 15. In another embodiment, the antenna device further comprises a second reflector and a second switch. Please refer to FIG. 3, FIG. 3 is a perspective schematic view of the antenna device according to another embodiment of the present disclosure. As shown in FIG. 3, the antenna device 1′, which is similar to the antenna device 1 shown in FIG. 1A, comprises the substrate 11′, the main antenna 13, the first reflector 15a, and the first switch 17a, wherein the composition and arrangement relationship of above components are similar to those of aforementioned embodiment and are not described herein again.

In the embodiment of FIG. 3, the antenna device 1′ further comprises a second reflector 15b and a second switch 17b in addition to the above components. The second reflector 15b, which is also similar to the reflector 15 of the embodiment shown in FIG. 1A, has a shorting end 151b and a free end 153b, wherein the shorting end 151b connects the installation surface 111′ of the substrate 11′ and the free end 153b connects the installation surface 111′ through the second switch 17b. Further, the substrate 11′ may comprise a first substrate 11a′ and a second substrate 11b′. The shorting end 151b of the second reflector 15b electrically connects to the first substrate 11a′, and the free end 153b selectively electrically connects to second substrate 11b′ through the second switch 17b according to conducting state of the second switch 17b. In addition, the second reflector 15b also extends away from the installation surface 111′. Further, in the embodiment shown in FIG. 3, the second reflector 15b, the first reflector 15a, and the main antenna 13 all extend in a direction of z-axis away from the installation surface 111′. However, in other embodiments, any two of the second reflector 15b, the first reflector 15a and the main antenna 13 may extend in the same direction or may extend in three different directions that the present disclosure does not limit herein.

The second switch 17b antenna device 1′ is also similar to the switch 17 of the embodiment as shown in FIG. 1A and the component's detail are not described herein again. In short, the second switch 17b may determine its conducting state according to the received control instruction so the free end 153b of the second reflector 15b may electrically connect to the substrate 11′ (i.e., to the ground) when the second switch 17b is closed and the free end 153b of the second reflector 15b is not grounded (i.e., stay in the free state) when the second switch 17b is open. FIG. 3 exemplarily shows that the first reflector 15a and the second reflector 15b form an angle of 180 degrees with respect to the main antenna 13. In other words, the angle between one reference line L1 from the position of first reflector 15a to the position of the main antenna 13 and another reference line L2 from the position of the second reflector 15b and the position of the main antenna 13 is 180 degrees. However, the present disclosure is not limited to this angle. In addition, the first switch 17a and the second switch 17b may receive the same control instruction or may separately receive two control instructions, the present disclosure does not limit herein.

In this embodiment, when both the first switch 17a and the second switch 17b are open, the radiation field generated by the antenna device 1′ is the original radiation field generated by the main antenna 13, that is, the pattern of the radiation field is as shown in FIG. 2A. When the first switch 17a is closed and the second switch 17b is open, as described in the previous embodiment, the equivalent length of the first reflector 15a is one quarter of the wavelength corresponding to the antenna resonant frequency. At this time, the first reflector 15a may reflect the original radiation field generated by the main antenna 13. Therefore, the antenna device 1′ can generate the radiation field having the pattern as shown in FIG. 2B. When the first switch 17a is open and the second switch 17b is closed, the second reflector 15b may reflect the original radiation field of the main antenna 13. At this time, the pattern of the radiation field generated by the antenna device 1′ is symmetrical with respect to the x-axis of the pattern shown in FIG. 2B. As described above, the radiation field pattern generated by the antenna device 1′ of this embodiment in different states can be derived from FIG. 2A and FIG. 2B of the previous embodiments, thus no further illustration.

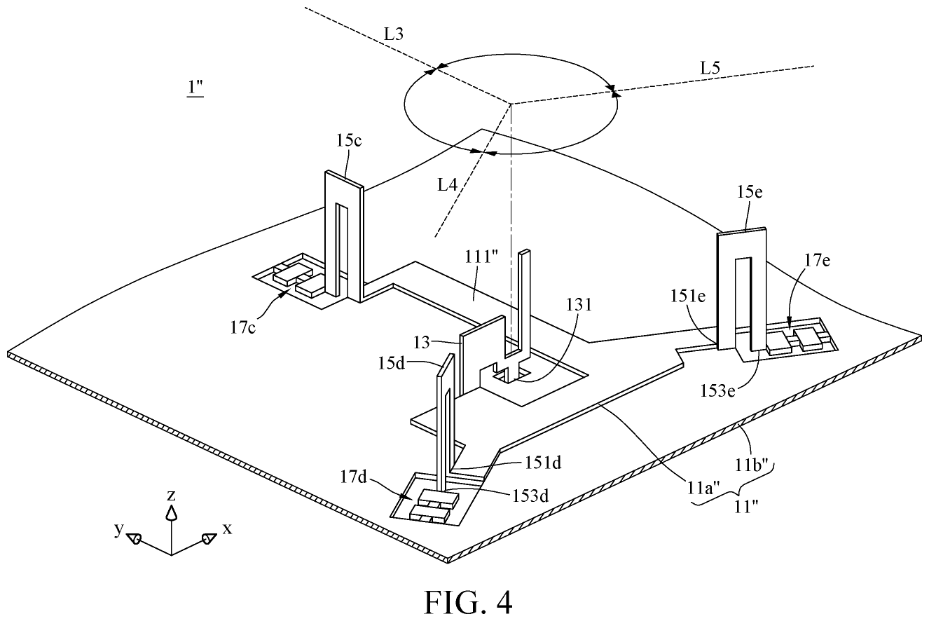

Next, please refer to FIG. 4, FIG. 4 is a perspective schematic view of the antenna device 1″ according to further another embodiment of the present disclosure. As shown in FIG. 4, the antenna device 1″, which is similar to the antenna device 1 of the embodiment as shown in FIG. 1A, comprises a substrate 11″, a main antenna 13, a first reflector 15c and a switch 17, wherein the composition and arrangement relationship of above components are similar to the substrate 11, the main antenna 13, the reflector 15, and the switch 17 of the aforementioned embodiment as shown in FIG. 1A and are not described herein again.

In the embodiment shown in FIG. 4, the antenna device 1″ further comprises a second reflector 15d, a third reflector 15e, a second switch 17d, and a third switch 17e in addition to the above components. Both the second reflector 15d and the third reflector 15e are similar to the reflector 15 of the embodiment shown in FIG. 1A, respectively having a shorting end 151d, 151e and a free end 153d, 153e, wherein the shorting end 151d, 151e connect to the installation surface 111″ of the substrate 11″ while the free end 153d, 153e connect to the installation surface 111″ through the second switch 17d and the third switch 17e, respectively.

Further, the substrate 11″ may comprise a first substrate 11a″ and a second substrate 11b″, wherein the shorting ends 151d, 151e of the second and the third reflector 15d, 15e electrically connect to the first substrate 11a′, and the free ends 153d, 153e of the second and the third reflector 15d, 15e selectively electrically connect to the second substrate 11b″ through the second and the third switch 17d, 17e, respectively. The second reflector 15d and the third reflector 15e respectively extend away from the installation surface 111″. Further, in this embodiment, the main antenna 13, the first reflector 15c, the second reflector 15d, and the third reflector 15e all extend away from the installation surface 111″ in the z-axis direction. In other embodiment, any two of the main antenna 13, the first reflector 15c, the second reflector 15d, and the third reflector 15e may extend away from the installation surface 111″ in the same direction, any of three extend away from the installation surface 111″ in the same direction, or all of them respectively extend away from the installation surface 111″ in four different directions, the present disclosure is not limited.

The second switch 17d and the third switch 17e of the antenna device 1″ are also similar to the switch 17 of the embodiment shown in FIG. 1A, and the component's detail are not described herein again. In short, the second switch 17d determines its conducting state according to the received control instructions, so the free end 153d of second reflector 15d may electrically connect to the substrate 11″ (i.e., to the ground) when the second switch 17d is closed, and the free end 153d of the second reflector 15d is not grounded (i.e., stay in the free state) when the second switch 17d is open. The third switch 17e also determines its conducting state according to the received control instructions, so the free end 153e of the third reflector 15e electrically connect to the substrate 11″ (i.e., to the ground) when the third switch 17e is closed, and the free end 153e of the third reflector 15e is not grounded (i.e., stay in the free state) when the third switch 17e is open.

FIG. 4 exemplarily shows the first reflector 15c, second reflector 15d, and the third reflector 15e are spaced apart from each other by 120 degrees with respect to the main antenna 13. In other words, an angle between a reference line L3 passing through the position of the first reflector 15c and the position of the main antenna 13 and another reference line L4 passing through the position of the second reflector 15d and the position of the main antenna 13 is 120 degrees, and another angle between the reference line L3 passing through the position of the first reflector 15c and the position of the main antenna 13 and further another reference line L5 passing through the position of the third reflector 15e and the position of the main antenna 13 is 120 degrees. However, the present disclosure does not limit the angle.

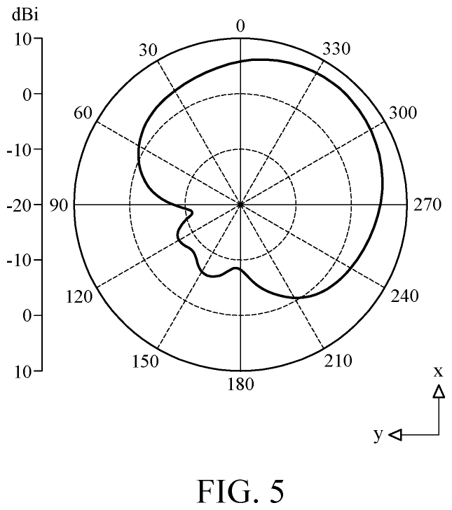

Please refer to FIG. 2A, FIG. 2B, FIG. 4, and FIG. 5 together to illustrate that the antenna device 1″ has different radiation field patterns according to the conducting states of the first switch 17c, the second switch 17d, and the third switch 17e. In this embodiment, when the first switch 17c, the second switch 17d, and the third switch 17e are all open, the radiation field generated by the antenna device 1″ is the original radiation field generated by the main antenna 13. That is, the radiation field is similar to the pattern shown in FIG. 2A. When the first switch 17c is closed and the second switch 17d and the third switch 17e are open, as described in previous embodiment of the antenna device having a reflector, the equivalent length of the first reflector 15c is one quarter of the wavelength corresponding to the resonant frequency of the antenna, and thus the original radiation field generated by the main antenna 13 is able to be reflected to form the second radiation field similar to the pattern shown in FIG. 2B. When the first switch 17c and the second switch 17d are closed and the third switch 17e is open, both the first reflector 15c and the second reflector 15d reflect the original radiation field of the antenna device 1″. Therefore, the antenna device 1″ may generate the third radiation field with the pattern shown in FIG. 5.

In conclusion, the antenna device provided by the present disclosure has a switch connected between the reflector and the ground point, and changes the pattern of the original radiation field generated by the main antenna through switching the conducting state of the switch to form a radiation field with directivity. Since the switch of the antenna device provided by the present disclosure is disposed between the reflector and ground point, the antenna device can maintain the power supply without interruption during the process of changing the radiation pattern, thereby avoiding the delay generated by the signal source interruption, and the radiation pattern switching without time difference is achieved.

What is claimed is:

1. An antenna device comprising:
a substrate with an installation surface, with said substrate configured to electrically connect to a ground point;
a main antenna connected to the installation surface, wherein the main antenna extends away from the installation surface, has a feeding end for receiving a signal, and is configured to form a resonance current path with the substrate to generate an original radiation field; and
a reflector with a shorting end and a free end, wherein the shorting end connects to the installation surface and the reflector extends away from the installation surface; and
a switch with a first end, a second end, and a control end, wherein the first end electrically connects to the free end of the reflector, the second end electrically connects to the substrate, and the control end is configured to selectively control the first end and the second end in a conductive connection.

2. The antenna device of claim 1, wherein the antenna device generates the original radiation field when the switch is open, and the antenna device reflects radiation of the original radiation field through the reflector to form a second radiation field when the switch is closed.

3. The antenna device of claim 1, wherein the substrate further comprises a first substrate and a second substrate electrically connecting with each other, the shorting end of the reflector electrically connects to the first substrate, and the free end of the reflector selectively and electrically connects to the second substrate through the switch.

4. The antenna device of claim 1, wherein the reflector is a structure in an upside down U-shape, one end of the structure connects to the substrate to serve as the shorting end, and another end of the structure extends in a direction to the installation surface to serve as the free end.

5. The antenna device of claim 1, wherein the switch comprises two diodes, two cathode ends of the two diodes serve as the first end and the second end of the switch respectively, and two anode ends of the two diodes electrically connect to each other to serve as the control end.

6. The antenna device of claim 1, wherein the reflector is a first reflector, and the antenna device further comprises:
a second reflector with a shorting end and a free end, with the shorting end of the second reflector connecting the installation surface and the second reflector extending away from the installation surface; and
a second switch with a first end, a second end, and a control end, wherein the first end of the second switch electrically connects to the free end of the second reflector, the second end of the second switch electrically connects to the substrate and the control end of the second switch is configured to selectively control the first end and the second end of the second switch in a conductive connection.

7. The antenna device of claim 6, wherein the first reflector and the second reflector are located on two opposite sides of the main antenna, and an angle between a reference line passing through the first reflector and the main antenna and another reference line passing through the second reflector and the main antenna is 180 degrees.

8. The antenna device of claim 6, further comprising:
a third reflector with a shorting end and a free end, wherein the shorting end of the third reflector connects the installation surface and the third reflector extends away from the installation surface; and
a third switch with a first end, a second end and a control end, wherein the first end of the third switch electrically connects to the free end of the third reflector, the second end of the third switch electrically connects to the substrate, and the control end of the third switch is configured to selectively control the first end and the second end of the third switch in a conductive connection.

9. The antenna device of claim 8, wherein the first reflector, the second reflector, and the third reflector form an angle of 120 degrees to each other relatively to the main antenna, wherein an angle between a reference line passing through the first reflector and the main antenna and another reference line passing through the second reflector and the main antenna is 120 degrees, and another angle between the reference line passing through the first reflector and the main antenna and further another reference line passing through the third reflector and the main antenna is 120 degrees.
